(19) United States
(12) Patent Application Publication
(10) Pub. No.: US 2008/0072624 A1
(43) Pub. Date: Mar. 27, 2008

(54) MANUFACTURING METHOD OF DRAWN GLASS MEMBER, MANUFACTURING METHOD OF SPACER FOR IMAGE DISPLAY APPARATUS, AND MANUFACTURING METHOD OF IMAGE DISPLAY APPARATUS

(75) Inventor: Nobuyuki Nakagawa, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/859,361

(22) Filed: Sep. 21, 2007

(30) Foreign Application Priority Data
Sep. 25, 2006 (JP) 2006-258269

(51) Int. Cl. C03B 23/037

(52) U.S. Cl. 65/106

(57) ABSTRACT

A glass base material which has an area where its heat capacity is bilaterally symmetric with respect to a center axis in a drawing direction is heated so that its temperature becomes bilaterally symmetric with distances from heaters to the glass base material being individually adjusted. As a result, highly accurate drawn glass members without warpage can be continuously obtained.

### BACKGROUND OF THE INVENTION

1. Field of the Invention

The present invention relates to a manufacturing method of drawn glass member using a heating drawing method, a manufacturing method of spacer for image display apparatus, and a manufacturing method of image display apparatus.

2. Description of the Related Art

Conventionally, an end portion of a glass base material heated and softened by a heating furnace is continuously pulled out of the heating furnace and drawn and simultaneously cooled, so that a drawn glass member having an approximately similar cross-sectional shape to that of the glass base material can be obtained. This method is used for manufacturing optical fiber base materials and spacers for panel type image display apparatuses.

An example of the method for manufacturing spacers for panel type image display apparatuses is described. A glass base material is drawn while it is heated so that its viscosity (log η) becomes 10⁵ to 10⁹ poise. As a result, similarity of the spacers with respect to the glass base material can be improved in such a manner. This is disclosed in, for example, Japanese Patent Application Laid-Open No. 2000-203857. A drawn glass member pulled out of a heating furnace is rapidly cooled by an outside atmosphere, so that compressive strength of a spacer to be obtained can be improved. This is disclosed in Japanese Patent Application Laid-Open No. 2003-317648. Further, when a formed drawn glass member is subject to an annealing process, a residual stress is reduced, so that deformation, warpage and breakage in the case where the drawn glass member is used as a spacer can be prevented. This is disclosed in Japanese Patent Application Laid-Open No. 2003-317653.

As described in Japanese Patent Application Laid-Open No. 2000-203857, however, even when the viscosity of the heated and softened glass base material is adjusted within a predetermined range, if the cross-section shape of the drawn glass member to be obtained is not line-symmetric, warpage might occur in the drawn glass member to be obtained. Drawn glass members are formed by continuously pulling out the end portions of the glass base materials. In that regard, even when the viscosity of the glass base material is maintained constant, if a temperature varies on a surface vertical to the pulling-out direction, a contraction amount varies in a lengthwise direction of the drawn glass member to be obtained. As a result, warpage might occur in the drawn glass member.

An object of the methods in the Japanese Patent Application Laid-Open Nos. 2003-317648 and 2003-317653 is originally not to repress the warpage, and thus these methods are not useful for the warpage of the drawn glass members to be obtained. The annealing process in Japanese Patent Application Laid-Open No. 2003-317648 is executed after a drawn glass member is once formed, namely, a drawing force is released and a cross-section size is fixed. Further, the annealing process is only for releasing the residual stress. Therefore, the warpage of the drawn glass members cannot be corrected. According to the inventors' knowledge, in fact, the rapid cooling due to the outside atmosphere in Japanese Patent Application Laid-Open No. 2003-317653 tends to promote the warpage of the drawn glass member to be obtained, depending on a temperature distribution in the cross section of drawn glass members and a rapid cooling direction.

### SUMMARY OF THE INVENTION

It is an object of the present invention to continuously obtain highly accurate drawn glass members without warpage.

It is another object of the present invention to improve a dimensional accuracy of a spacer for an image display apparatus so as to easily obtain an image display apparatus with high quality.

The present invention provides a manufacturing method of a drawn glass member by drawing and cooling one end of a heated and softened glass base material so as to manufacture a drawn glass member having a cross-section shape similar to the glass base material. In this method, the glass base material which has an area where its heat capacity is bilaterally asymmetric with respect to a center axis in a drawing direction is heated so that temperature of the glass base material becomes bilaterally symmetric.

### BRIEF DESCRIPTION OF THE DRAWINGS

FIG. 1 is a schematic constitutional diagram illustrating an image display apparatus to which a spacer manufactured by the manufacturing method of drawn glass member according to the present invention is applied;

FIG. 2 is an explanatory diagram illustrating a first example of the manufacturing method of the spacer for the image display apparatus according to the present invention;

FIG. 3 is an explanatory diagram illustrating the first example of the manufacturing method of the spacer for the image display apparatus according to the present invention;

FIG. 4 is an explanatory diagram illustrating a second example of the manufacturing method of the spacer for the image display apparatus according to the present invention;

FIG. 5 is a shape explanatory diagram illustrating one example of a glass base material and the drawn glass member; and

FIG. 6 is a shape explanatory diagram illustrating a state of warpage in the drawn glass member.

### DESCRIPTION OF THE PREFERRED EMBODIMENTS

The first invention is a method of manufacturing a drawn glass member having a similar cross-section shape to that of the glass base material by drawing one end of a heated and softened glass base material and simultaneously cooling it. In this method, the glass base material, which has an area where its heat capacity is bilaterally asymmetric with respect to a center axis in a drawing direction is heated so that temperature of the glass base material becomes bilaterally symmetric.

The second invention is a method of manufacturing a spacer for an image display apparatus using the drawn glass member. In this method, the drawn glass member is manufactured by the manufacturing method of the drawn glass according to the present invention.

The third invention is a method of manufacturing an image display apparatus whose two panels are opposed via a spacer and periphery is sealed. In this method, the spacer is manufactured by the manufacturing method of the spacer for the image display apparatus according to the present invention.

According to the first invention, temperature distribution of glass from a position where a width or a radius of a heated and softened glass base material starts to be thin through another position where the pulled-out drawn glass member is not cooled and is not drawn is always maintained constantly with respect to a center axis in the drawing direction. For this reason, a contraction amount of the drawn glass member to be obtained becomes constant, so that drawn glass members having rectilinear advance property without warpage can be continuously obtained.

According to the second and third inventions, the image display apparatus which has high quality and uses a highly accurate spacer can be easily obtained.

The adjustment of the viscosity of the heated and softened glass base material within a predetermined range is not newly proposed in Japanese Patent Application Laid-Open No. 2000-203857, and thus is a very general method in the drawn glass member manufacturing method using the heating drawing method.

The glass base material has an area where the heat capacity is bilaterally asymmetric with respect to the center axis in the drawing direction of the glass base material. The inventors find that this causes warpage of the drawn glass member to be obtained, and thus devise the present invention. That is to say, since temperature irregularity occurs in a base material, which has a distribution of the heat capacity bilaterally asymmetric with respect to the center axis in the drawing direction of the glass base material, due to a difference in surface area and a difference in volume, the warpage occurs in this base material.

The drawn glass member manufacturing method of the present invention can be used for not only the manufacturing of the spacer for the image display apparatus but also manufacturing of an optical fiber base material, for example. Since particularly the spacer of the image display apparatus requires high dimensional accuracy, the method of the present invention which can achieve shape reproducibility with accuracy of ±several μm is preferably applied to the manufacturing of the spacer of the image display apparatus.

The method of manufacturing the image display apparatus using the spacer of the image display apparatus is described concretely below as an example of the present invention.

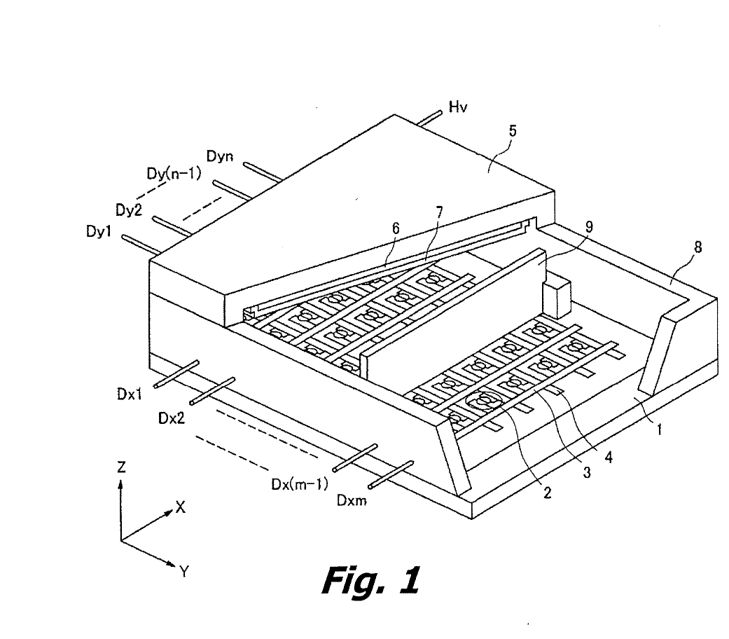

FIG. 1 is a schematic constitutional diagram illustrating an image display apparatus to which the spacer manufactured by the manufacturing method of drawn glass member of the present invention is applied.

A rear plate 1 is formed with an electron source where a plurality of electron-emitting devices 2 are wired in a matrix pattern by a plurality of row-direction wirings 3 and a plurality of column-direction wirings 4.

A face plate 5 is formed with a fluorescence substance 6 and a metal back 7 as an anode electrode.

In the image display apparatus, electrons are emitted from the electron source formed on the rear plate 1 according to an image signal. The emitted electrons are accelerated by the metal back 7 which is formed on the face plate 5 and to which a high voltage of 1 kV to 20 kV is applied. The fluorescence substance 6 is irradiated with the emitted electrons. As a result, an image according to the image signal is displayed. As the electron-emitting devices 2 composing the electron source, a field emission type device (FE), an MIM type electron-emitting device or a surface-conduction electron-emitting device which is well known conventionally is used.

The rear plate 1 and the face plate 5 are adhered to an outer frame 8 arranged therebetween by a sealing material. The rear plate 1, the face plate 5 and the outer frame 8 compose an airtight container.

The airtight container has vacuum of 10⁻⁴ to 10⁻⁶ Pa, and a plurality of spacers 9 are disposed in the airtight container. The spacers are disposed as structures which support air pressure to be applied to the aright container from within.

An embodiment of the manufacturing method of the spacers for the image display apparatus is described below with reference to the drawings.

### First Embodiment

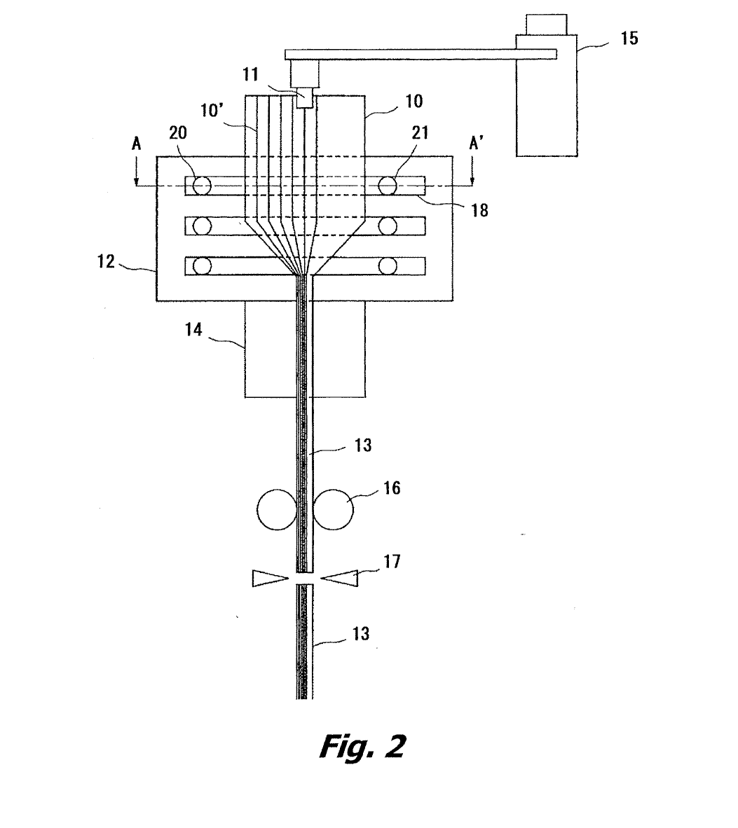

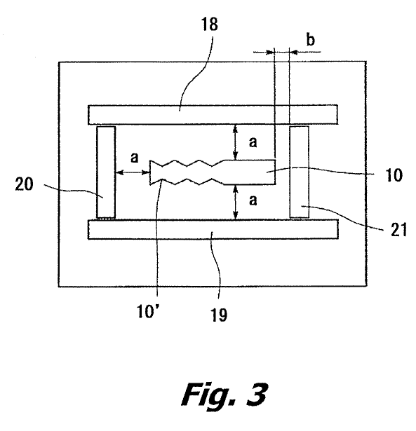

FIGS. 2 and 3 are explanatory diagrams illustrating a first example of the method for manufacturing the spacer of the image display apparatus according to the present invention. FIG. 3 is a sectional view taken along line A-A′ of FIG. 2.

For example, “SK18” manufactured by Sumita Optical Glass, Inc. is used as the glass base material 10 which is drawn into the spacer 9 of the image display apparatus.

One end of the glass base material 10 processed into a predetermined shape (having a groove 10′) is held by a holding member 11 of a base material feeding device 15. The holding member 11 gradually descends by means of the base material feeding device 15, and the other end of the glass base material 10 is fed into a heating furnace 12 containing heater coils 18 to 21. The other end of the glass base material 10 is continuously pulled out and is heated and softened to a drawing enabled temperature. As the heating temperature, a temperature which is not less than a softening temperature is suitably selected. As to a positional relationship between the glass base material 10 and the heater coils 18 to 21, the heater coils 18 and 19 are in positions separated equally by a distance “a” from the side surfaces of a long side of the base material 10. On the other hand, the heater coil 20 is in a position separated by a distance “a” from the side surface of a short side of the base material 10, but heater coil 21 is in a position separated by a distance “b” shorter than the distance “a” from the side surface of the short side of the base material 10. This is because the groove 10′ is provided on one side of the base material 10 and this prevents temperature irregularity generated due to a difference in surface area and a difference in volume in the base material (right and left in the drawing). Comparing a portion of the glass base material where the groove is present with a portion without the groove, the surface area of the portion with the groove is larger by about 15%, and its volume is smaller by about 5%. That is to say, in the case where the equal heat quantity is provided, the portion with the groove is more easily heated, and its temperature becomes higher than that of the portion without the groove.

The feeding speed of the glass base material 10 into the heating furnace 12 by means of the base material feeding device 15 is normally about 1 to 5 mm/min. The temperature in the heating furnace 12 is set depending on types of the glass base material 10 so that the viscosity log η of the end portion of the glass base material 10 fed into the heating furnace 12 becomes 7.0 to 7.9 poise. The temperature is preferably controlled with accuracy of ±0.1° C. from a viewpoint of drawing stability.

The end portion of the glass base material 10 heated to the temperature in the heating furnace 12 is softened and droops and is drawn so as to be a drawn glass member 13. The drawn glass member 13 is drawn and is simultaneously pulled out of the heating furnace 12 into a cylindrical cover 14 provided continuously with the heating furnace 12.

The cover 14 has heat shielding property, and its length in the drawing direction of the drawn glass member 13 is suitably set so that temperature gradient can be formed in the cover 14. The temperature gradient is such that the temperature gradually drops along the drawing direction. The temperature gradient includes, for example, softening temperature T1 of the glass base material 10 through solidifying temperature T2 or temperature less than T2. The drawn glass member 13 is being drawn and moving in the cover 14, and is cooled to a temperature at which the drawn glass member 13 is solidified. The drawing is then completed.

The drawn glass member 13 which is cooled to the temperature at which it is solidified in the cover 14 and has been drawn is nipped by a pair of taking-up rollers 16 so as to be taken off.

The taking-up speed of the drawn glass member 13 by means of the taking-up rollers 16 is preferably 1000 to 5000 mm/min. A ratio between the feeding speed and the taking-up speed (taking-up speed/feeding speed) is preferably 200 to 2000 from the viewpoint of securing of similarity in a cross-section shape between the glass base material 10 and the drawn glass member 13 which has been drawn.

The drawn glass member 13 which passes through the taking-up rollers 16 is cut by a cutter 17, so that a thin-plate shaped or pillar shaped drawn glass member 13′ having a required length is obtained. The drawn glass member 13′ is occasionally used directly as the spacer 9 (see FIG. 1), but normally is further processed so that the spacer 9 is formed. A surface coating material or a surface processing material can be continuously applied to the surface of the drawn glass member 13 before cutting. When the drawn glass member 13 is taken out in a long form, it can be used as an optical fiber base material.

A convection flow in the cover 14 generated due to heat becomes stable and the cover 14 is hardly influenced by a flow of an external air. For this reason, the temperature gradient in the cover 14 becomes stable, and the drawn glass member 13 is cooled to the temperature at which it is solidified. Therefore, the drawn glass members 13 and 13′ and spacer 9 (see FIG. 1) to be manufactured have excellent shape reproducibility.

In the case where the cover 14 is not provided, the shape reproducibility of the drawn glass member 13 to be manufactured is deteriorated. This is because the drawn glass member 13, which is heated and softened by the heating furnace 12 and is being drawn and simultaneously pulled out of the heating furnace 12, is exposed with ambient turbulent flow just after being taken out of the heating furnace 12. As a result, the temperature of the drawn glass member 13 fluctuates irregularly.

When the spacer 9 (see FIG. 1) is manufactured, the drawn glass member 13′ can be further subject to a cutting process for adjusting a dimension or can be subject to a process for coating the surface of the drawn glass member 13′ with a resistance film. The resistance film is formed in order to prevent the surface of the spacer 9 from being charged due to emission of electrons emitted from the electron source in the image display apparatus shown in FIG. 1.

The surface of the drawn glass member 13′ can be coated with the resistance film by a vacuum evaporating method, a sputtering method, a CVD method or a plasma CVD method. The film thickness is 10 nm to 1.0 μm, preferably 50 nm to 500 nm, and surface resistance of the resistance film is preferably 10⁷ to 10¹⁴ Ω/□.

For example, a metal oxide can be used as a material of the resistance film. In the metal oxide, chrome, nickel or copper oxide is preferable. This is because these oxides have comparatively small secondary electron emission efficiency, and even if electrons bump against the spacers, they are hardly charged. Besides the metal oxides, carbon is a preferable material because its secondary electron emission efficiency is small. Particularly amorphous carbon has high resistance, and can easily control the resistance of the spacers to a desirable value. Other materials such as nitride of germanium and transition metal alloy, and nitride of aluminum and transition metal alloy are practically used because the composition of the transition metal alloys is adjusted so that the resistance value can be controlled in a wide range from a conductor with high conductivity through an insulator.

The spacers 9 manufactured in such a manner are fixed to the face plate 5 formed with the fluorescence substance 6 and the metal back 7 or to the rear plate 1 formed with the electron source shown in FIG. 1. A sealing material such as frit glass or In is provided on the outer frame 8, and the face plate 5, the outer frame 8 and the rear plate 1 are sealed in a vacuum chamber so that the above-mentioned degree of vacuum is obtained in the airtight container to be formed. As a result, an image display panel is manufactured.

The spacer 9 obtained by the present invention has no warpage in the longitudinal direction and has satisfactory rectilinear advance property. For this reason, height accuracy between the face plate 5 and the rear plate 1 is ±several μm which is satisfactory in the respective spacers 9 and between the plurality of spacers 9. As a result, distortion on the image display surface, buckling and collapse of the spacers 9 at the time of sealing and after sealing can be prevented. After the image display panel is formed, a driving circuit for image display is mounted so that the image display apparatus is manufactured.

### Second Embodiment

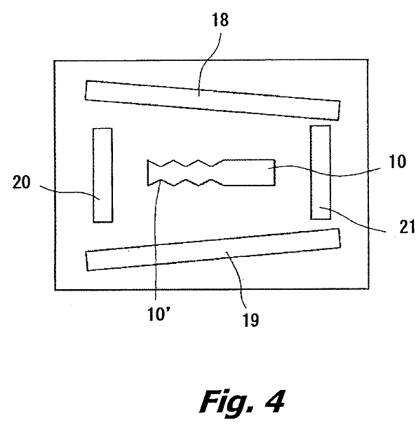

FIG. 4 is an explanatory diagram illustrating a second example of the method for manufacturing the spacer for the image display apparatus according to the present invention. In FIG. 4, the same reference numerals as those in FIG. 3 designate the same members and portions.

Basically, the example in FIG. 4 is similar to the first example shown in FIGS. 2 and 3, but a different point is that the heater coils 18 and 19 which heat mainly the long sides of the glass base material 10 are gradually separated from each other towards the groove 10′ of the glass main material 10.

In the case where the heaters which heat the long sides of the glass base material are gradually separated, similarly to the case shown in FIG. 3, the temperature irregularity caused by the difference in the surface area and volume of the base material (right and left in the drawing) can be prevented. As a result, the drawn member without warpage can be obtained.

The cutting into the drawn glass member 13′, the further process for manufacturing the spacer 9 (see FIG. 1) which is executed if necessary, and the manufacturing procedure for the image display apparatus are similar to those described in the first example.

### Third Embodiment

In this embodiment, the distances between the heater coils 18 to 21 and the glass base material 10 in FIG. 3 are constant, but the diameter of the heater 21 is made to be larger than those of the heaters 18 to 20, so that the radiant energy amount is increased.

In this example, the glass base material, which has an area where the heat capacity is bilaterally asymmetric with respect to the center axis in the drawing direction, can be heated so that the temperature of the glass base material is bilaterally symmetric. For this reason, the drawn glass members 13 and 13′ and the spacers 9 (see FIG. 1) to be manufactured have excellent rectilinear advance property, and the spacers 9 to be obtained have satisfactory shape reproducibility. Therefore, the height accuracy between the face plate 5 and the rear plate 1 shown in FIG. 1 is satisfactory in the respective spacers 9 and between the plurality of spacers 9. As a result, distortion on the image display surface, buckling and collapse of the spacers 9 at the time of sealing and after sealing can be prevented.

### Example 1

In this example, the spacers for the image display apparatus were manufactured by using the method in the first embodiment.

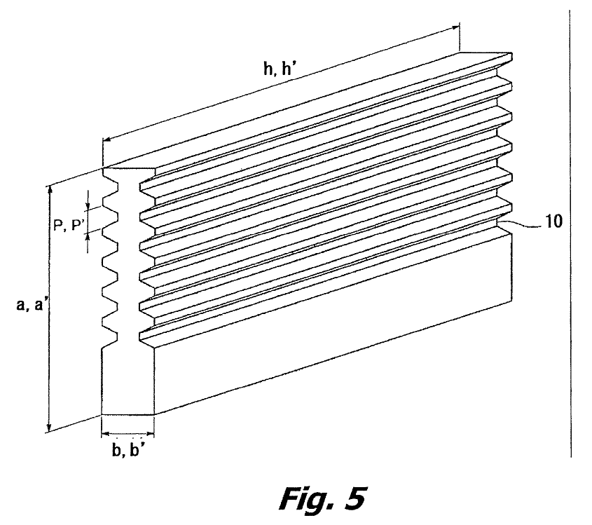

As the glass base material 10, as shown in FIG. 5, glass whose rectangular cross-section shape (long dimension a×short dimension b) is 49.23 mm×6.15 mm, length h is 600 mm, softening temperature is 770° C. and glass transition temperature is 640° C. is used. A plurality of grooves 10′ extending to the lengthwise direction h are arranged in a line on both surfaces of the long side “a” of the glass base material 10, at a groove pitch P of about 1 mm. Namely, unevenness is formed on both the surfaces of the long side “a”.

The glass base material 10 is held by the holding member 11 so that the lengthwise direction h is the drawing direction. The holding member 11 is allowed to descend at a speed of 5 mm/min, and the end portion of the glass base material 10 is fed into the heating furnace 12 in which the heaters 18 to 21 are disposed. In this example, “a” shown in FIG. 3 is set to 60 mm and “b” is set to 40 mm. The temperature in the heating furnace 12 is controlled to 780° C. (±0.1° C.) at which the glass base material 10 has viscosity log η of 7.5 poise.

The end portion of the glass base material 10 fed into the heating furnace 12 is being softened and being drawn, and droops. The drawn glass member 13 is allowed to pass through the cover 14 which is provided continuously with the heating furnace 12.

The cover 14 is made of stainless (material) having excellent heat shielding property similar to the external wall of the heating furnace 12. The length of the cover 14 is 120 mm from the lower end of the heating furnace 12.

The taking-up speed of the paired taking-up rollers 16 for taking up the drawn glass member 13 which passes through the cover 14 and is already solidified is 4733 mm/min. (The taking-up speed/feeding speed)=about 947.

The drawn glass member 13 is drawn so that the rectangular cross-section shape (long side a′×short side b′) is 1.6 mm×0.2 mm. The drawn glass member 13 which passes through the taking-up rollers 16 is cut by the cutter 17, so that ten thin-plate shaped drawn glass members 13′ with length h′ of 825 mm are formed.

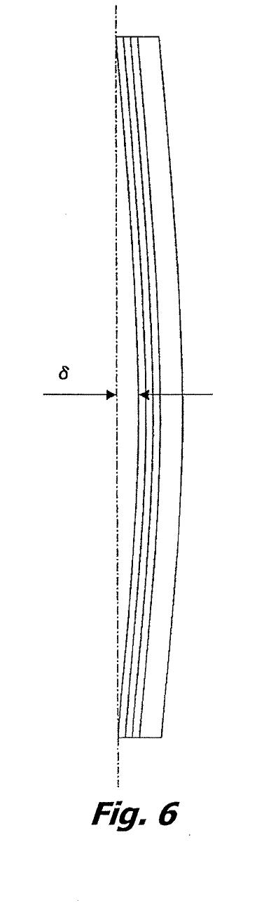

As to the ten drawn glass members 13′, the dimension accuracy is measured. A warpage amount δ shown in FIG. 6 is 0.2 mm±0.1 mm. In the case where all the distances from the heaters 18 to 21 to the glass base material 10 is 60 mm, a temperature difference is about 10° C. Since the contraction amount on the right and left portions differs due to the influence of the temperature difference at the cooling process, accordingly the warpage of about 4 mm occurs.

As to deviations in the dimensions of the long side a′ and the short side b′ in the lengthwise direction h′ of each drawn glass member 13′, the deviation of the long side a′ is ±2 μm, and the deviation of the short side b′ is ±1 μm. A deviation of the groove pitch P′ in the lengthwise direction h′ of each drawn glass member 13′ is ±0.1 μm, and a deviation between the parallel groove pitches P′ is ±0.3 μm. A deviation in the dimension of the long side a′ among the ten drawn glass members 13′ is ±4 μm, and a deviation in the dimension of the short side b′ is ±2 μm, and a deviation of the groove pitches P′ is ±0.5 μm.

The resistance film with thickness of 200 nm is formed on the surface of the drawn glass members 13′ obtained in the above manner by using a W—Ge target according to a reactive sputtering method in the presence of mixed gas including argon and nitrogen. The resistance film is made of a nitrogen compound consisting of tungsten and germanium. Specific resistance of the deposited nitrogen compound film including tungsten and germanium in this example is 7.9×10³ Ωm. A Pt electrode is formed on the surfaces which touch the row-direction wirings 3 and the metal back 7 shown in FIG. 1 by the sputtering method, so that the spacers 9 of the image display apparatus are formed.

The spacers 9 are fixed onto the row-direction wirings 3 of the rear plate 1 shown in FIG. 1, and the outer frame 8 is fixed to the rear plate 1.

Indium as a sealing material is applied to the outer frame 8. Thereafter, the rear plate 1 and the face plate 5 formed with the fluorescence substance 6 and the metal back 7 are conveyed into the vacuum chamber whose degree of vacuum is 10⁻⁶ Pa. The sealing material is heated and the outer frame 8 is sealed with the face plate 1 so that the image display panel is manufactured. Thereafter, a driving circuit for image display is mounted, so that the image display apparatus is manufactured.

The image display apparatus of this example manufactured in the above manner has high quality without the distortion on the image display surface and the buckling and collapse of the spacers at the time of sealing and after sealing.

### Example 2

In this example, the drawn glass members 13′ to be used for manufacturing the spacer for the image display apparatus are manufactured by the method of the second embodiment.

The glass base material 10 similar to that in the example 1 is held by the holding member 11, and the holding member 11 is allowed to descend at a speed of 5 mm/min. The end portion of the glass base material 10 is fed into the heating furnace 12 in which the heaters 18 to 21 are arranged. In this example, the distances from the heaters 18 and 19 to the glass base material 10 are 45 mm in the closest position and 65 mm in the farthest position. The distance from the heater 20 to the glass base material 10 is 40 mm, and the distance from the heater 21 to the glass base material 10 is 40 mm. The temperature of the heating furnace 12 is controlled to 780° C. (±0.1° C.) at which the viscosity long η of the glass base material 10 becomes 7.5 poise.

The end portion of the glass base material 10 fed into the heating furnace 12 is being softened and being drawn and simultaneously droops. The drawn glass member 13 is allowed to pass through the cover 14 which is provided continuously with the heating furnace 12.

The drawn glass member 13 which passes through the cover 14 and is already solidified is taken up by the pair of taking-up rollers 16 similarly to the example 1.

The glass base material 10 is drawn so that its rectangular cross-section shape (long side a′×short side b′) becomes 1.6 mm×0.2 mm, and ten plate-shaped drawn glass members 13′ with length h′ of 825 mm are formed.

As a result of measuring the dimensional accuracy of the ten drawn glass members 13′, the warpage amount 6 is 0.3 mm±0.1 mm. A deviation in the dimension of the long side a′ in the lengthwise direction h′ of the each drawn glass member 13′ is ±2 μm, and a deviation in the dimension of the short side b′ is ±1 μm. A deviation of the groove pitch P′ in the lengthwise direction h′ of each drawn glass member 13′ is ±0.1 μm, and a deviation of the groove pitches P′ arranged in parallel is ±0.3 μm. A deviation in the dimension of the long sides a′ of the ten drawn glass members 13′ is ±4 μm, and a deviation in the dimension of the short sides b′ is 2 μm, and a deviation of the groove pitch P′ is ±0.5 μm.

### Example 3

In this example, the drawn glass members 13′ to be used for manufacturing the spacers for the image display apparatus are manufactured by the third embodiment.

The glass base material 10 similar to that in the example 1 is held by the holding member 11, and the holding member 11 is allowed to descend at a speed of 5 mm/min. The end portion of the glass base material 10 is fed into the heating furnace 12 in which the heaters 18 to 21 are arranged. All the distances from the glass base material 10 to the heaters 18 to 21 are 60 mm. A heater whose diameter is larger than that of the heaters 18 to 21 is used as a heater 21. The radiant energy amount from the heater 21 is controlled to a predetermined radiant energy amount which is larger than that of the heaters 18 to 20. The temperature in the heating furnace 12 is controlled to 780° C. (±0.1° C.) so that the viscosity log η of the glass base material 10 becomes 7.5 poise.

The end portion of the glass base material 10 fed into the heating furnace 12 is being softened and being drawn and simultaneously droops. The drawn glass member 13 is allowed to pass through the cover 14 which is provided continuously with the heating furnace 12.

The drawn glass member 13 which passes through the cover 14 and is already solidified is taken up by the pair of taking-up rollers 16 similarly to the example 1.

The glass base material 10 is drawn so that its rectangular cross-section shape (long side a′×short side b′) becomes 1.6 mm×0.2 mm, and ten plate-shaped drawn glass members 13′ with length h′ of 825 mm are formed.

As a result of measuring the dimensional accuracy of the ten drawn glass members 13′, the warpage amount δ is 0.3 mm±0.1 mm. A deviation in the dimension of the long side a′ in the lengthwise direction h′ of the respective drawn glass members 13′ is ±2 μm, and a deviation in the dimension of the short side b′ is ±1 μm. A deviation of the groove pitch P′ in the lengthwise direction h′ of the each drawn glass member 13′ is ±0.1 μm, and a deviation of the groove pitches P′ arranged in parallel is ±0.3 μm. A deviation in the dimension of the long sides a′ of the ten drawn glass members 13′ is ±4 μm, and a deviation in the dimension of the short sides b′ is 2 μm, and a deviation of the groove pitch P′ is ±0.5 μm.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2006-258269 filed on Sep. 25, 2006 which is hereby incorporated by reference herein.

What is claimed is:

1. A manufacturing method of a drawn glass member having a cross-section shape similar to a glass base material by drawing and cooling one end of the heated and softened glass base material, wherein the glass base material which has an area where its heat capacity is bilaterally asymmetric with respect to a center axis in a drawing direction is heated so that temperature of the glass base material becomes bilaterally symmetric.

2. A manufacturing method of a spacer for an image display apparatus using a drawn glass member, wherein the drawn glass member is manufactured by the manufacturing method according to claim 1.

3. A manufacturing method of an image display apparatus, the image display apparatus being constituted so that two panels are opposed via a spacer and a periphery of the panels are sealed, wherein the spacer is manufactured by the manufacturing method according to claim 2.
